(19) United States
(12) Patent Application Publication
(10) Pub. No.: US 2017/0152159 A1
(43) Pub. Date: Jun. 1, 2017

(54) REVERSE OSMOSIS WITH RECTIFICATION

(71) Applicant: John E. Stauffer, Greenwich, CT (US)

(72) Inventor: John E. Stauffer, Greenwich, CT (US)

(21) Appl. No.: 14/954,172

(22) Filed: Nov. 30, 2015

(51) Int. Cl. C02F 1/44; B01D 61/02

(52) U.S. Cl. CPC C02F 1/441; B01D 61/022; C02F 2103/08

(57) ABSTRACT

Two or more reverse osmosis filtration units are assembled together such that rectification of the retentate and permeate streams is provided.

### FIELD OF THE INVENTION

A process for reverse osmosis encompassing rectification is provided for the desalination of salt water. A principal attribute of the process is the significant reduction in operating pressure compared with current practice.

### BACKGROUND OF THE INVENTION

In many regions of the world, there is a growing demand for fresh water as supplies fail to keep pace with demand. To meet this demand, desalination of seawater or brackish water is becoming increasingly important. Three technologies are the principal means of achieving desalination: Distillation, electrodialysis, and reverse osmosis. Of these three methods, reverse osmosis shows the most promise.

Reverse osmosis (RO) gets its name by the fact that the natural phenomenon of osmosis is run backwards by applying pressure across a permeable membrane. Thus, when pressure is applied to a salt solution next to a porous membrane, pure water will be drive through the membrane, leaving dissolved salt behind. In the early development of RO, membranes were made of cellulose acetate; newer materials consist of polyamide resins deposited on a polysulphone backing.

Although simple in concept, RO is demanding in its execution. Seawater containing 3.5 percent salt must be converted to potable water with no more than 0.05 percent dissolved solids. To operate successfully, the process must raise the pressure of the seawater feed to a level in the range of 60 to 68 atmospheres, or about 1000 psi. This requirement necessitates a substantial input of energy.

The high pressures required for RO places a burden on the equipment used. Vessels, piping and pumps all need to be of durable construction. Even more demanding is the stress placed on the membrane. For this reason, extreme care must be taken to support the membrane and to maintain its integrity.

In spite of improvements in RO, this process remains challenging. Attempts to recover some of the energy used have proven to be futile. Construction and operating costs are high. With these drawbacks, the application of RO has remained limited.

For these and other reasons, there is an incentive to make improvements in RO. The need for such advancements is great. With this goal in mind, the present invention offers a process with noteworthy innovations. The features, advantages and applications of this process will become apparent from the following description.

### BRIEF SUMMARY OF THE INVENTION

A process for reverse osmosis comprising rectification is provided by the present invention. In one embodiment, the process uses first and second filtration units which are interconnected such that the retentate from the second filtration unit becomes the feed to the permeate side of the first unit and the permeate from the first unit becomes the feed to the retentate side of the second unit. As a result, saltwater to be desalinated is fed to the retentate side of the first unit and brine is discarded from the same side. The permeate from the second unit is the freshwater product.

In another illustrated embodiment comprising more than two filtration units, the units are interconnected by feed streams such that the permeate from one unit is fed by pumping or otherwise to the next downstream unit and the retentate from that unit is fed back to the upstream unit. Accordingly, the countercurrent streams become enriched, one stream increasing in salinity while the other becomes refined or less salty.

Two or more filtration units are connected by feed streams such that the permeate from one unit is pumped to the downstream unit and the retentate from that unit is fed to the upstream unit. Accordingly, these countercurrent steams become enriched, one stream increasing in salinity while the other becoming more refined or less salty. The term “rectification” is used herein to mean the purification of a liquid by means of successive filtration steps.

The present invention is applicable to the desalination of seawater or brackish water. When seawater is the feed, it is pumped to the retentate side of the first filter unit and brine is withdrawn once filtrate has permeated the membrane filter. Fresh water product is withdrawn from the permeate side of the last filter unit.

### BRIEF DESCRIPTION OF THE DRAWINGS

FIG. 1 shows a filter unit for reverse osmosis as in the current practice;

FIG. 2 is a representation of the present invention with two filter units;

FIG. 3 shows an arrangement for multiple filter units using rectification as specified by the present invention; and

FIG. 4 shows the results of calculations for an example in which three filter units are used.

### BRIEF DESCRIPTION OF ILLUSTRATIVE EMBODIMENTS

In order to appreciate the workings of the present invention, some knowledge of the relevant physics is necessary.

When a salt solution is separated from pure water by a semipermeable membrane, water will seep from the purse water through the membrane into the salt water. If the volume of the salt water is constrained, the salt water will exert a pressure known as the osmotic pressure.

The osmotic pressure of a solution will depend on several factors including the nature of the dissolved salt, its concentration, and the temperature. The osmotic pressure can be quantified by the following expression known as the Van't Hoff equation.

Π=kCT

In the above equation, Π represents the osmotic pressure, k is a constant, C is the salt concentration and T is the absolute temperature. When sodium chloride is the solute, k will vary slightly with concentration, but this deviation is low for the most practical purposes.

Reverse osmosis is achieved by applying sufficient pressure to a salt solution to overcome the osmotic pressure. Now water will pass through the membrane in the reverse direction so that it flows from salt water into fresh water. In practice, an excess of pressure is used in order to achieve acceptable flow rates.

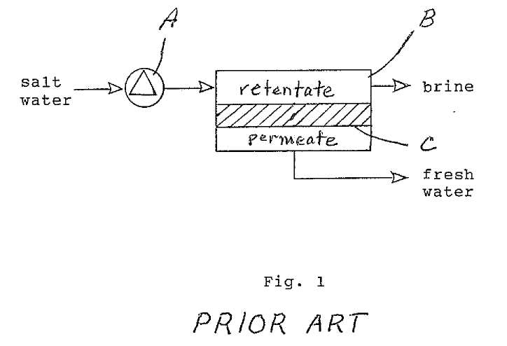

This description of reverse osmosis is a good example of how the technology is practiced today. The state of the art is illustrated in FIG. 1. Salt water is fed by high pressure pump A to the retentate side of membrane type filtration unit B. Brine is discarded from the retentate side after losing water that passes through membrane C. Fresh water is recovered from the permeate side D of unit B.

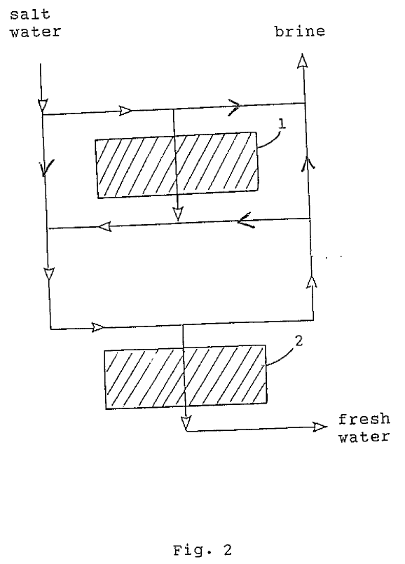

In contrast with existing RO technology, the present invention provides for the rectification of countercurrent streams that connect two or more filtration units. Such an arrangement is shown in FIG. 2 for two RO units. In this layout, the permeate from unit 1 is pumped to unit 2 and the retentate from unit 2 is fed to unit 1.

The advantage of combining filtration with rectification can be seen from a case study. Again referring to FIG. 2, the saltwater feed as a concentration of 3.5 percent and the fresh water product has close to zero salinity. As shown by a material balance, the concentration of salt in the permeate of unit 1 may be 1.75 percent. Because the concentration gradient is only half of that encountered in conventional RO units, the pressure of the saltwater feed can be reduced to 500 psi from the usual 1000 psi.

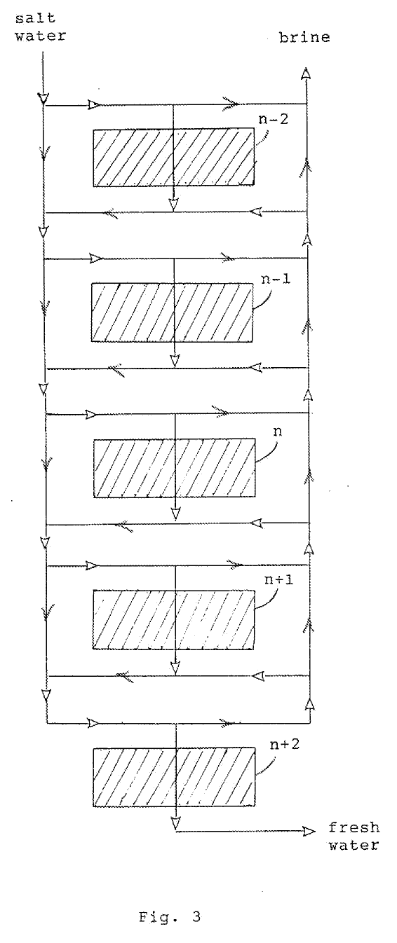

The rectification format shown in FIG. 2 can be extended to any number of filtration units as illustrated in FIG. 3. This particular arrangement has five RO units 8, 10, 12, 14, and 16. For further explanation purposes, unit 12 is denominated “n,” unit 10 is “n−1” and unit 14 is n+1. Referring to FIG. 3, the retentate from unit n becomes the feed to the permeate side of unit n−1, and permeate from unit n becomes the feed to the retentate side of unit n+1. With the use of five filtration units, the pressure drop across each unit is reduced to 200 psi.

For maximum energy efficiency, the pressure of each retentate exit stream can be recovered. In this manner, the pressure of the permeate of each RO unit can be raised when discarded. Regenerative pumps are suitable for this procedure.

The modest pressures required by the present invention have numerous benefits. Equipment costs can be reduced significantly. The membrane requirements are more flexible. This result should be a great help in designing new and more advanced materials for porous membranes.

No breakthroughs in technology are required to facilitate the adoption of the present invention. The risks involved with this process are minimal. The potential rewards, on the other hand, are substantial and justify a major effort in this direction.

Aside from its use in the desalination of salt water, membrane filtration can be used for separating solutes from solvents in non-aqueous solutions. This technology has general applicability in chemical synthesis where solvents, reactants, products and catalysts need to be recovered. In these applications, the use of membrane filtration can be cost-effective.

### Example

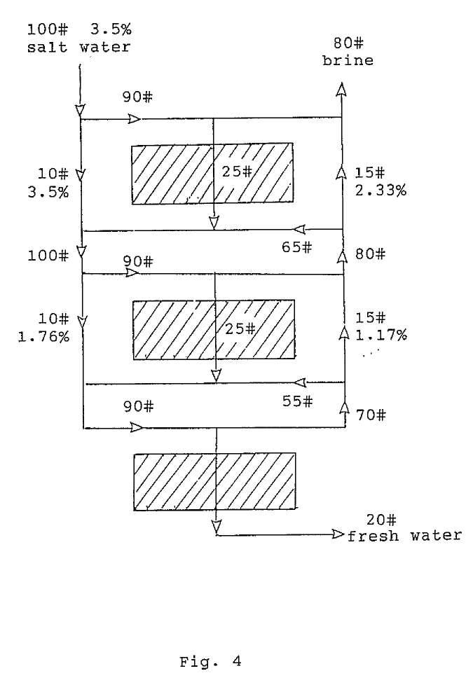

FIG. 4 illustrates the results for a reverse osmosis installation with rectification employing three filter units 18, 20, and 22. These results are quite dramatic. As can be noted, the differential salt concentration across each filter unit is 1.17 pound of salt per hundred pounds of solution or one-third the concentration drop if only one unit is used.

What is claimed:

1. A process for the desalination of salt water to produce freshwater using first and second osmotic filtration units, each of which comprises a membrane dividing the unit into permeate and retentate sides, wherein the process comprises the steps of:
a. feeding the retentate from the second unit to the permeate side of the first unit;
b. feeding the permeate from the first unit to the retentate side of the second unit;
c. feeding the saltwater to the retentate side of the first unit; and
d. discarding brine from the retentate side of the first unit
whereby the permeate from the second unit is the freshwater product.

2. A process for the desalination of salt water by reverse osmosis using two or more filtration units each of which comprises a membrane dividing the unit into retentate and permeate sides wherein the process uses countercurrent streams according to the steps of:
a. feeding the retentate from unit n to the permeate side of the unit n−1;
b. feeding the permeate from unit n to the retentate side of unit n+1; and
c. feeding saltwater to the retentate side of unit n−1 while brine is discarded from said retentate side whereby the permeate from unit n+1 is the desalinated water product.
